(19) United States
(12) Patent Application Publication
(10) Pub. No.: US 2011/0125780 A1
(43) Pub. Date: May 26, 2011

(54) ELECTRONIC DEVICE CAPABLE OF AUTOMATICALLY TRANSMITTING FILES AND METHOD THEREOF

(75) Inventors: WEI-DA YANG, Tu-Cheng (TW); CHEN-HUANG FAN, Tu-Cheng (TW)

(73) Assignee: HON HAI PRECISION INDUSTRY CO., LTD., Tu-Cheng (TW)

(21) Appl. No.: 12/817,197

(22) Filed: Jun. 17, 2010

(30) Foreign Application Priority Data
Nov. 20, 2009 (CN) 200910310141.2

(51) Int. Cl. G06F 17/30

(52) U.S. Cl. 707/769; 707/827; 707/E17.01; 707/E17.014

(57) ABSTRACT

A method for automatically transmitting files applied in an electronic device is provided. The electronic device stores a plurality of files and information associated with files executed by the electronic device. The information of each of the files executed by the electronic device includes a file name, a storage path, a plurality of execution commands, and an execution time corresponding to each of the execution commands. The method includes: receiving image content including time information from an external device communicating with the electronic device; obtaining the time information from the received image content; comparing the time information with the stored execution time to determine the content of which file is displayed and visible at the obtained time; and finding the determined file according to the file name and the storage path of the file and transmitting the file to the external device. A related electronic device is also provided.

### BACKGROUND

1. Technical Field

The present disclosure relates to electronic devices capable of automatically transmitting files and, particularly, to an electronic device capable of automatically transmitting files to other electronic devices according to requests from the other electronic devices and a method thereof.

2. Description of Related Art

By conventional file transmitting methods, when attempting to transmit files from an electronic device, such as a computer, to an external device, such as a mobile phone, users have to find and select the files in the electronic device, which is time consuming. Especially in certain public showings, when an audience is interested in the content of a file displayed via a terminal and wants to obtain the file, he/she has to inform an operator of the terminal that he/she wants to obtain the file, and then the operator finds and selects the file in the terminal, which is inconvenient.

### BRIEF DESCRIPTION OF THE DRAWINGS

The components of the drawings are not necessarily drawn to scale, the emphasis instead being placed upon clearly illustrating the principles of an electronic device capable of automatically transmitting files and a method thereof. Moreover, in the drawings, like reference numerals designate corresponding parts throughout several views.

FIG. 1 is a block diagram of an electronic device capable of automatically transmitting files in accordance with an exemplary embodiment.

FIG. 2 is a flowchart of a method for automatically transmitting files in accordance with an exemplary embodiment.

### DETAILED DESCRIPTION

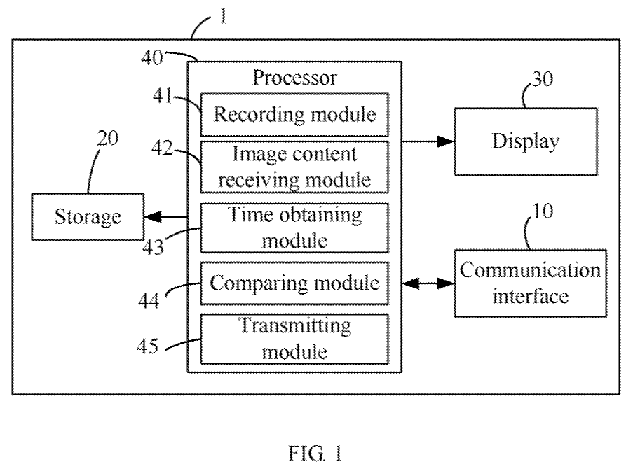

Referring to FIG. 1, an embodiment of an electronic device 1 capable of automatically transmitting files is illustrated. The electronic device 1 includes a communication interface 10. The electronic device 1 can communicate with other electronic devices (not shown) via the communication interface 10. The electronic device 1 further includes a storage 20, a display 30, and a processor 40.

The storage 20 stores a plurality of files, for example, a POWERPOINT file a.ppt, a WORD file b.doc. The storage 20 further stores execution information associated with the files executed by the electronic device 1. The electronic device 1 can determine at what time the content of which file is displayed and visible and can find where the determined file is according to the execution information. In the embodiment, the execution information of each of the files executed by the electronic device 1 includes a file name, a storage path, a plurality of execution commands applied to the file, and an execution time corresponding to each of the execution commands. The execution commands include a display command for causing the content of one file to be visible and a hide command for causing the content of one file to be invisible. The execution time of each of the files executed by the electronic device 1 includes a first execution time corresponding to the display command and a second execution time corresponding to the hide command.

The processor 40 includes a recording module 41, an image content receiving module 42, a time obtaining module 43, a comparing module 44, and a transmitting module 45.

The recording module 41 is configured to record the execution information associated with the files executed by the electronic device 1, and store the execution information in the storage 20.

The image content receiving module 42 is configured to receive image content from an external device (not shown) communicating with the electronic device 1. The image content includes an image and image attributes. The image attributes include time information indicating when the external device creates the image. In the embodiment, when a user is interested in the content of one file displayed on the display 30, the user can use the external device to take an image of the displayed content and the created image is transmitted to the electronic device 1.

The time obtaining module 43 is configured to obtain the time information from the received image content.

The comparing module 44 is configured to compare the obtained time information with the stored execution time to determine the content of which file is displayed and visible at the obtained time. Specifically, the comparing module 44 searches in the storage 20 to determine that it is the content of a file whose first execution time is earlier than the obtained time, and whose second execution time is later than the obtained time, that is displayed and visible at the obtained time.

The transmitting module 45 is configured to find the determined file according to the file name and the storage path of the determined file and transmit the determined file to the external device via the communication interface 10.

With such configuration, the external device can obtain an interested file from the electronic device 1 via transmitting an image to the electronic device 1, without the user of the external device or a principal of the electronic device 1 finding and selecting the interesting file in the electronic device 1, which conserves time.

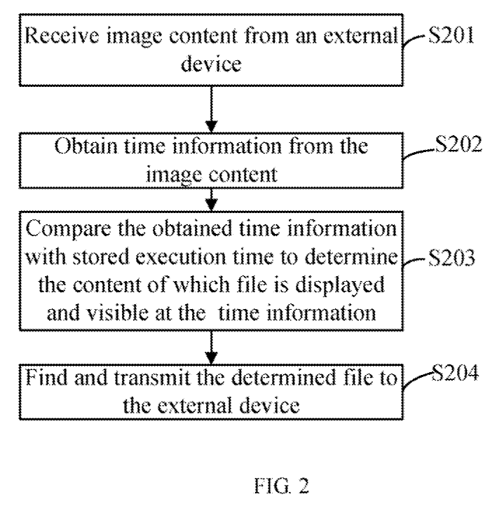

Referring to FIG. 2, a flowchart of a method for automatically transmitting files is illustrated.

In step S201, the receiving module 42 receives image content from an external device communicating with the electronic device 1. The image content includes an image and image attributes. The image attributes include time information indicating when the external device creates the image.

In step S202, the obtaining module 43 obtains the time information from the received image content.

In step S203, the comparing module 44 determines the content of which file is displayed and visible at the obtained time information. Specifically, the comparing module 44 searches in the storage 20 to determine that it is the content of a file whose first execution time is earlier than the obtained time, and whose second execution time is later than the obtained time, that is displayed and visible at the obtained time.

In step S204, the transmitting module 45 finds the determined file according to the file name and the storage path of the determined file and transmits the determined file to the external device via the communication interface 10.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device capable of automatically transmitting files, comprising:
a communication interface;
a storage configured to store a plurality of files and execution information associated with some of the plurality of files executed by the electronic device, the execution information of each of the files executed by the electronic device comprising a file name, a storage path, a plurality of execution commands applied to the file, and an execution time corresponding to each of the execution commands; and
a processor comprising:
a recording module configured to record the execution information associated with the files executed by the electronic device and store the execution information in the storage;
an image content receiving module configured to receive image content from an external device communicating with the electronic device via the communication interface, the image content comprising time information;
an obtaining module configured to obtain the time information from the received image content;
a comparing module configured to compare the obtained time information with the stored execution time to determine the content of which file is displayed and visible at the obtained time; and
a transmitting module configured to find the determined file according to the file name and the storage path of the determined file and transmit the determined file to the external device via the communication interface.

2. The electronic device as described in claim 1, wherein the image content further comprises an image, the time information indicates when the external device creates the image.

3. The electronic device as described in claim 1, wherein the execution commands comprise a display command for causing the content of one file to be displayed and visible, and a hide command for causing the content of one file to be invisible.

4. The electronic device as described in claim 1, wherein the comparing module compares the obtained time information with the stored execution time to determine the content of which file is displayed and visible at the obtained time comprises: the comparing module searches in the storage to determine that it is the content of a file whose execution time corresponding to the display command is earlier than the obtained time, and whose execution time corresponding to the hide command is later than the obtained time, that is displayed and visible at the obtained time information.

5. A method for automatically transmitting files applied in an electronic device, the electronic device storing a plurality of files and execution information associated with some of the plurality of files executed by the electronic device, the execution information of each of the files executed by the electronic device comprising a file name, a storage path, a plurality of execution commands, and an execution time corresponding to each of the execution commands, the method comprising:
receiving image content from an external device communicating with the electronic device, the image content comprising time information;
obtaining the time information from the received image content;
comparing the obtained time information with the stored execution time to determine the content of which file is displayed and visible at the obtained time information; and
finding the determined file according to the file name and the storage path of the determined file and transmitting the determined file to the external device.

6. The method as described in claim 5, wherein the image content further comprises an image, the time information indicates when the external device creates the image.

7. The method as described in claim 5, wherein the execution commands comprise a display command for causing the content of one file to be displayed and visible, and a hide command for causing the content of one file to be invisible.

8. The method as described in claim 5, wherein the method of comparing the obtained time information with the stored execution time to determine the content of which file is displayed and visible at the obtained time information comprises:
searching in the electronic device to determine that it is the content of a file, whose execution time corresponding to the display command is earlier than the obtained time, and whose execution time corresponding to the hide command is later than the obtained time information, that is displayed and visible at the obtained time.
